(19) United States
(12) Patent Application Publication
(10) Pub. No.: US 2008/0137350 A1
(43) Pub. Date: Jun. 12, 2008

(54) Protective Venting System for Self-Contained Marine and Aviation Lighting Equipment

(75) Inventors: Rongsheng Tian, Newark, DE (US); James R. Hoelsworth, Cape May Court House, NJ (US); Sean Xiaolu Wang, Wilmington, DE (US)

Correspondence Address: BWT PROPERTY, INC., 19 SHEA WAY, SUITE 301, NEWARK, DE, 19713, US

(73) Assignee: BWT PROPERTY, INC., Newark, DE (US)

(21) Appl. No.: 11/950,944

(22) Filed: Dec. 5, 2007

Related U.S. Application Data
(60) Provisional application No. 60/869,180, filed on Dec. 8, 2006.

(51) Int. Cl. F21V 15/00

(52) U.S. Cl. 362/362

(57) ABSTRACT

A protective venting system is disclosed for self-contained marine and aviation lighting equipments. The venting system is capable of preventing battery gas buildup in the enclosure of the lighting equipment as well as maintaining its pressure equilibrium with the outside environment. In addition, the venting system is water and dust proof to prevent debris or ice buildup.

### REFERENCE TO RELATED APPLICATIONS

This application claims an invention which was disclosed in Provisional Patent Application No. 60/869,180, filed Dec. 8, 2006, entitled “Protective Venting System for Self-Contained Marine and Aviation Lighting Equipment.” The benefit under 35 USC § 119(e) of the above mentioned U.S. Provisional Applications is hereby claimed, and the aforementioned applications are hereby incorporated herein by reference.

### FIELD OF THE INVENTION

This invention generally relates to a venting system, and more specifically to a protective venting system for self-contained marine and aviation lighting equipment.

### BACKGROUND

Self-contained marine and aviation lighting equipments relates to those lighting equipments that can operate autonomously with minimum human intervention for a long period of time, e.g. several months or even years. These lighting equipments are generally powered by solar panel charged rechargeable batteries. The capability to maintain their performance during a predetermined lifespan is a top priority for this kind of lighting equipments. However, changing environment conditions, such as temperature, dust, salt, and moisture may considerably impact the performance of these lighting equipments. For example, rain or splashing sea water can cool down the enclosure of the lighting equipment dramatically, causing a vacuum of 150 mbar or more inside the enclosure. To equalize the pressure, air and moisture are drawn through the seal into the enclosure where the moisture condenses on the cooler inner walls. This can considerably impair the performance of the electronic system of the lighting equipment. In another aspect, the rechargeable battery may release battery gases such as hydrogen and oxygen in the event that the battery is abused or over-charged. Buildup of these battery gases in the enclosure of the lighting equipments may pose an explosion hazard.

There thus exists a need of a protective venting system for self-contained marine and aviation lighting equipments. The venting system should be capable of preventing battery gas buildup in the enclosure of the lighting equipment as well as maintaining its pressure equilibrium with the outside environment. In addition, the venting system should be water and dust proof to prevent debris or ice buildup.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1a illustrates an exemplary marine lighting equipment with the disclosed protective venting system;

FIG. 1b illustrates the structure of the protective venting system;

FIG. 1c is a vertical cross-section view of the protective venting system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a protective venting system for self-contained marine and aviation lighting equipment. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

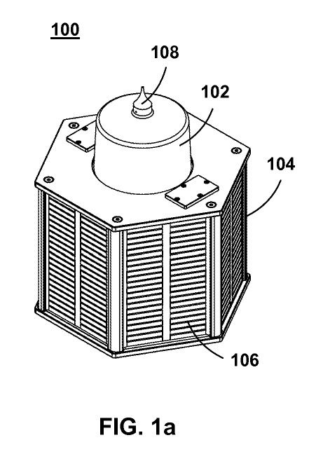

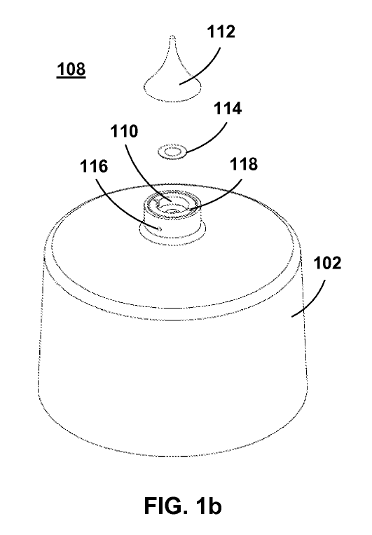

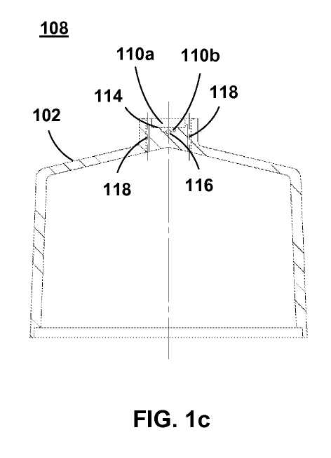

Referring to FIG. 1a-c, an exemplary embodiment of the protective venting system is disclosed, which is used on a marine lighting equipment. Referring to FIG. 1a, the enclosure of the marine lighting equipment 100 comprises two communicated chambers, i.e. a lighting chamber 102 and an electronic chamber 104. The lighting chamber 102 encloses the light sources (not shown) of the lighting equipment 100, whereas the electronic chamber 104 encloses the rechargeable batteries and electronic circuits (not shown) that drive the light sources. The rechargeable batteries are further powered by solar panels 106 implemented on outside of the electronic chamber 104. On top of the lighting chamber 102 is a protective venting system 108 which is used to prevent battery gas buildup as well as to maintain pressure equilibrium of the enclosure with the environment. The venting system 108 is placed on top of the lighting chamber 102 so that it will not obstruct the light emitted from the lighting equipment 100.

The structure of the protective venting system 108 is further illustrated in FIG. 1b and FIG. 1c. The venting system 108 comprises a small gas chamber 110, which is separated by a GORE™ type membrane 114 into two parts. The bottom gas chamber 110b communicates with the outside environment through a side ventilation hole 116, while the top gas chamber 110a communicates with the lighting chamber 102 through two top ventilation holes 118. A cone shaped top cover 112 placed on top of the top gas chamber 110a seals it from the outside environment. The GORE™ type membrane 114 available from W. L. Gore & Associates is water/oil repellent but vapor permeable. Thus it provides superior airflow and liquid resistance at the same time. Through the two top ventilation holes 118, the membrane 114, and the side ventilation hole 116, the lighting chamber 102 communicates with the outside environment and maintains its pressure equilibrium with the environment. Batteries gases (such as hydrogen) released by the rechargeable batteries will be ventilated through the same passage into the environment due to their lower density than that of the air. In the present invention, the GORE™ type membrane 114 is placed on top of the side ventilation hole 116, thus the solid or liquid debris (such as dust, salt, ice, or oil) coming from the outside environment will not accumulate on it.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A protective venting system for self-contained marine and aviation lighting equipments, the venting system comprising:
a first gas chamber communicating with outside environment of the lighting equipment;
a second gas chamber positioned on top of the first gas chamber, the second gas chamber communicating with inside environment of the lighting equipment; and
a water/oil repellent yet vapor permeable membrane positioned between the first gas chamber and the second gas chamber for providing vapor communication between the two chambers yet preventing water/oil permeation from the first gas chamber into the second gas chamber.

2. The protective venting system of claim 1, wherein the first gas chamber and the second gas chamber are situated on a top position of the lighting equipment.
